(19) United States
(12) Patent Application Publication
(10) Pub. No.: US 2016/0134545 A1
(43) Pub. Date: May 12, 2016

(54) SYSTEM AND METHOD FOR DELIVERING SUBSCRIBER SERVICES

(71) Applicant: Ari Sodhi, Markham (CA)

(72) Inventor: Ari Sodhi, Markham (CA)

(21) Appl. No.: 14/539,178

(22) Filed: Nov. 12, 2014

(51) Int. Cl. H04L 12/801; H04L 12/803; H04L 12/26

(52) U.S. Cl. CPC H04L 47/15; H04L 43/062; H04L 47/122

(57) ABSTRACT

Techniques for tracking and adjusting packet flows through a network having a service delivery node and one or more demarc points. Packet flows recognized as they pass through one or more demarc point and flow analytics information corresponding to the packet flows are transferred from the demarc points to the flow identification control unit. The flow analytics information is analyzed within the flow identification control unit and traffic through one or more of the service access platform and the demarc points is adjusted, if necessary, as a function of the flow analytics information analyzed by the flow identification control unit.

### BACKGROUND

A network flow is a data stream that carries information between a source and a destination. As streaming video and other timing sensitive services become more ubiquitous, it has become important to recognize and prioritize traffic based on content of each network flow, e.g., in the presence of network congestion. It also has become important to simplify access to such content, and make it easier to access the content in a location agnostic manner.

### BRIEF DESCRIPTION OF THE FIGURES

FIG. 1 illustrates a system with distributed flow identification;

FIG. 2 illustrates another system with distributed flow identification;

FIG. 3 illustrates a method of analyzing flows;

FIG. 4 illustrates another method of analyzing flows;

FIG. 5 illustrates a virtual appliance representation of a virtual flow identification system;

FIG. 6 illustrates a method of switching flows between demarc points; and

FIG. 7 illustrates a method of suspending and reestablishing a flow through virtual demarc points.

### SUMMARY

In one example, this disclosure is directed to a method, in a network having a service access platform connected to two or more demarcation points and to a flow identification control unit, wherein the demarcation points include a first and a second demarcation point wherein the service access platform distributes packet flows to the demarcation points, a method of switching flows between demarcation points, the method comprising recognizing, within each demarcation point, packet flows passing through the demarcation point, transferring flow analytics information corresponding to the packet flows recognized in the demarcation points from the demarcation points to the flow identification control unit, analyzing, within the flow identification control unit, the flow analytics information received from the demarcation points, establishing a first packet flow to a user through the first demarcation point, wherein establishing includes creating a secure communications path through the first demarcation point and transferring the first packet flow to the user via the secure communications path through the first demarcation point, and reestablishing the first packet flow to the user through the second demarcation point, wherein reestablishing includes creating a second secure communications path through the second demarcation point, retrieving configuration parameters associated with the transfer of the first packet flow through the first demarcation point and transferring the first packet flow to the user via the second secure communications path using the configuration parameters.

In another example, this disclosure is directed to a flow transfer method, in a network including a service access platform connected to one or more demarcation points and to a flow identification control unit, wherein the service access platform distributes packet flows to the demarcation points, including a first and a second demarcation point, the flow transfer method comprising recognizing, within each demarcation point, packet flows passing through the demarcation point, transferring flow analytics information corresponding to the packet flows recognized in the demarcation points from the demarcation points to the flow identification control unit, analyzing, within the flow identification control unit, the flow analytics information received from the demarcation points, and adjusting traffic through one or more of the service access platform and the demarcation points as a function of the flow analytics information analyzed by the flow identification control unit, wherein adjusting includes storing configuration parameters of flows through the first demarcation point that are associated with a user, suspending one or more of the flows associated with the user, authenticating the user through the second demarcation point, and reestablishing the suspended flows through the second demarcation point, wherein reestablishing includes adjusting the reestablished flows as a function of the stored configuration parameters.

In another example, this disclosure is directed to a system for distributing content, comprising a flow identification control unit, a plurality of demarcation points, including a first and a second demarcation point, wherein each demarcation point includes a flow identification (FI) agent, wherein the flow identification agent on each demarcation point analyzes packet flows through the demarcation point and communicates the packet flow identifications to the flow identification control unit, and a service delivery node communicatively coupled to the flow identification control unit and to the demarcation points, wherein the service delivery node includes a service access platform and a flow identification agent, wherein the flow identification agent identifies packet flows through the service access platform and communicates the packet flow identifications to the flow identification control unit, wherein the flow identification control unit analyzes the flow analytics information received from the demarcation points and the service delivery node and stores the analysis in memory, and wherein a user connected to the first demarcation point is able to suspend one or more of the flows associated with the user through the first demarcation point, authenticate the user through the second demarcation point and reestablish the suspended flows through the second demarcation point, wherein reestablishing includes adjusting the reestablished flows as a function of transfer parameters associated with the flow through the first demarcation point.

In another example, this disclosure is directed to a method of modifying network traffic through a network having a service delivery node connected to one or more demarcation points, including a first and a second demarcation point, to a flow identification control unit and to an external network, wherein the service delivery node distributes packet flows to the demarcation points, the method comprising recognizing, within each demarcation point, packet flows passing through the demarcation point, transferring flow analytics information corresponding to the packet flows recognized in the demarcation points from the demarcation points to the flow identification control unit, recognizing, within the service delivery node, packet flows passing through the service access platform and the service access node to one or more demarcation points, transferring flow analytics information corresponding to the packet flows recognized in the service access platform and the service access node from the service delivery node to the flow identification control unit, analyzing, within the flow identification control unit, the flow analytics information received from the demarcation points and the service delivery node, adjusting traffic through the service access node, the service access platform and the demarcation points as a function of the flow analytics information analyzed by the flow identification control unit, wherein adjusting includes storing configuration parameters of flows through the first demarcation point that are associated with a user, suspending one or more of the flows associated with the user, authenticating the user through the second demarcation point, and reestablishing the suspended flows through the second demarcation point, wherein reestablishing includes adjusting the reestablished flows as a function of the stored configuration parameters.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Conventional flow identification (FI) and Deep Packet Inspection (DPI) systems are stand-alone systems. Flow Identification (FI) recognizes particular flows; traffic can then be adjusted as needed based on the traffic characteristics of a given flow. Deep Packet Inspection (DPI) goes further. DPI can support a form of packet filtering that examines the data and portions of the header as the packet passes through a DPI engine. DPI engines can be standalone devices that are inline or in a mirrored configuration, or reside in a network device, e.g., router, optical network unit (ONU), and optical line terminal (OLT). DPI can not only identify a flow, but inspect the flow to detect security problems such as viruses, spam, and attempted intrusions. Therefore, network flow identification can be used not only to support Quality of Service (QoS) tools, but also to reveal malware and hacking attempts disguised as normal network traffic.

Conventional flow identification (FI) and Deep Packet Inspection (DPI) systems are either placed in line with the traffic or connected in a mirror configuration so that they receive mirrored traffic. U.S. patent application Ser. No. 14/034,282, filed by Brower et al. on Sep. 23, 2013, describes a way to lower the cost of flow identification and DPI by embedding flow identification and deep packet processing into network elements in such a way that the logic is distributed across the access network, the description of which is incorporated herein by reference. In one described approach, one can coordinate inspection of high line rate traffic by separating the inspection into 1) detection and isolation of traffic of interest (called “Fast Path FI”) and 2) its analysis (called “Deep FI”). Such an approach increases utility and efficiency while reducing the cost of providing flow identification throughout the network by capitalizing on synergies with pre-existing network packet processing functions. In addition, Brower et al. describe how the distributed nature of the approach can be hidden from the user by a centralized controller that virtualizes the distributed system into appearing like a monolithic appliance, the description of which is incorporated herein by reference.

As content providers become more entrenched, users often can access the same provider through two or more locations. For instance, a user may be able to access content from the same provider at home, at work, and at locations such as coffeehouses. Although demarcation (or “demark”) points can physical or virtual, it can be advantageous to virtualize the demarc point in a network that delivers content, e.g., in a network enhanced residential gateway. For instance, a cable user might want to watch the beginning of a program at home, pause the program and then resume playback from another location. Systems that virtualize the demarc point for that user simplify the transition from one location to another as will be detailed below. In one approach, flow identification is used to recognize flows of interest and provide the services and content negotiated at the start of the program even if the user moves to another location with a different demarc point.

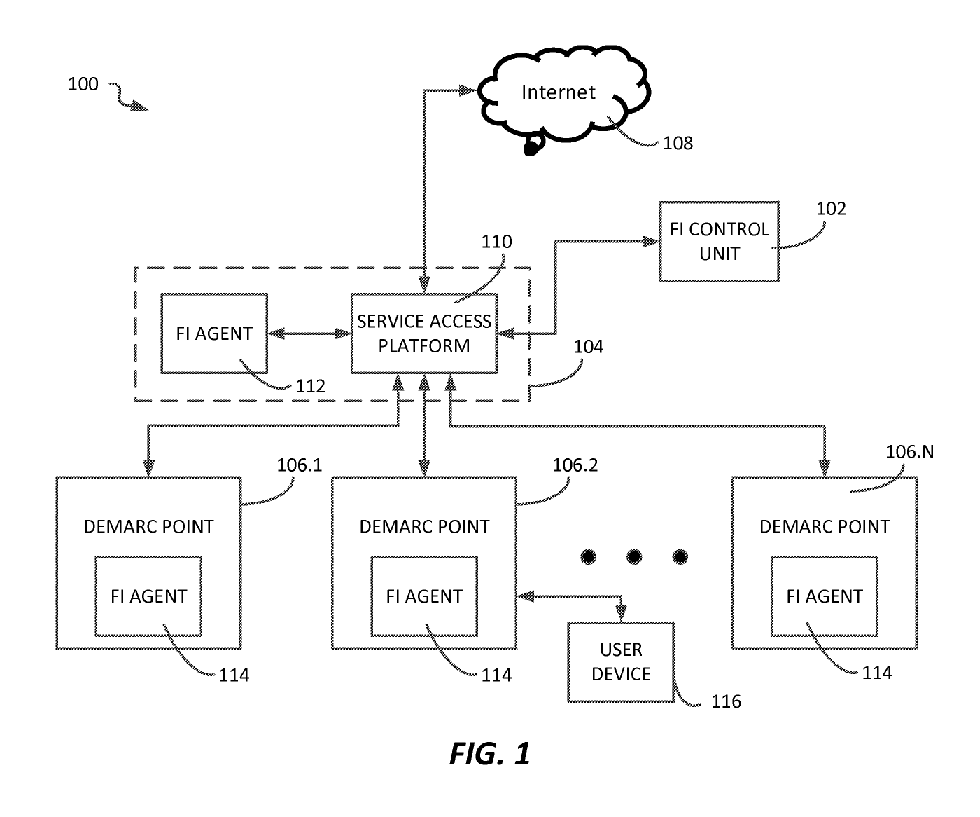

A system with distributed flow identification is shown in FIG. 1. In system 100 of FIG. 1, flow identification control unit 102 is communicatively connected to an external network 108, to a service delivery node 104 and to one or more demarc points 106. In one embodiment, service delivery node 104 includes a service access platform 110 and a flow identification agent 112. Service access platform 110 receives content from external network 108 and routes that content to one or more demarc points 106, such as, for example, a residential services gateway. In one embodiment, service access platform 110 delivers data and video to demarc points 106 via fiber technology, allowing service providers to provide a variety of services to their household, academic and business customers. In one embodiment, each FI agent 112 includes DPI analysis capability. In one embodiment, each FI agent 112 is a software-based or hardware-based agent (or combination thereof) that performs DPI functions with scope over the subscriber network that includes the demarc points 106 being serviced by platform 110.

In the embodiment shown in FIG. 1, each demarc point 106 includes a flow identification agent 114 that operates on flows that pass through the demarc point 106 to devices such as user device 116. In one embodiment, each FI agent 114 includes DPI analysis capability. In one embodiment, each FI agent 114 is a software-based or hardware-based agent (or combination thereof) that performs DPI functions with scope over the subscriber network.

In one embodiment, flow identification control unit 102 is connected to FI agents 114 in demarc points 106 and to the FI agent 112 in service delivery node 104. In one such embodiment, an application running in control unit 102 coordinates distributed DPI elements in node 104 and demarc points 106, e.g., a virtual or physical demarc point, and provides a virtualized appliance view augmented with insight from multiple points in the network. This enables one to add value-added applications such as network analytics, network security, traffic engineering, application level QoS (like Netflix), application Blacklisting/Whitelisting (like BitTorrent), etc. In one such embodiment, control unit 102 coordinates the selection of the application signatures the distributed DPI elements search for in a federated manner. It also controls how the detected application signatures are treated such that they can be mirrored to other DPI appliances (e.g., FI agent 112 or one of the services gateway FI agents 114) for post processing or processed inline by one of the FI agents.

In one embodiment, system 100 is a packet flow inspection system, comprising a flow identification control unit 102, a plurality demarc points 106, and a service delivery node 104 communicatively coupled to the flow identification control unit 102 and to the demarc points 106. Each demarc point 106 includes a flow identification (FI) agent 114, wherein the flow identification agent on each demarc point analyzes packet flows through the demarc point and communicates the packet flow identifications to the flow identification control unit.

In one such embodiment, the service delivery node 104 is communicatively coupled to the flow identification control unit 102 and to the demarc points 106. The service delivery node 104 includes a service access platform 110 and a flow identification agent 112. The flow identification agent 112 identifies packet flows through the service access platform 110 and communicates the packet flow identifications to the flow identification control unit 102.

In one embodiment, the flow identification control unit 102 analyzes the flow analytics information received from demarc points 106 and the service delivery node 104 and adjusts packet traffic through the service access platform 110 and through the demarc points 106 as a function of the flow analytics information. In some embodiments, the adjustment is in the form of prioritizing some packet flows over others, e.g., to address latency/jitter needs of the flow. Other adjustments include, for instance, isolation of particular flows, the deprioritizing or blocking of flows (e.g., deprioritizing or blocking file downloads in favor of Netflix traffic, or based on a signature), applying a blacklist or whitelist, gathering additional data (via, e.g., analysis software embedded in the demarc points) and identifying patterns for future identification and blocking

In one embodiment, flow identification control unit 102 instructs one or more of the flow identification agents 114 in the demarc points to perform deep packet inspection on flows identified by the flow identification agent 112. The flow identification agents 114 perform deep packet inspection on the indicated flows and forward the results of the deep packet inspection to the flow identification control unit 102.

In one embodiment, flow identification control unit 102 instructs flow identification agent 112 to perform deep packet inspection of selected flows. The flow identification agent 112 performs deep packet inspection on the indicated flows and forwards the results of the deep packet inspection to the flow identification control unit 102.

In one embodiment, flow identification control unit 102 instructs flow identification agent 112 to perform fast path flow identification inspection of flows. The flow identification agent 112 performs inspection on flows passing through service delivery node 104 and forwards the results of the inspection to the flow identification control unit 102.

In one embodiment, a distributed DPI messaging protocol is used to coordinate DPI handling through the distributed system. The distributed DPI messaging protocol is a messaging protocol used by the controller 102 and the agents (112, 114) to coordinate DPI handling through the distributed system. This includes coordination of what application/traffic signatures to search for, and notification of detection of an application signature of interest.

In some embodiments, Application/Traffic signatures of interest change over time and locality. In one such embodiment, each signature can be based on a definition that characterizes a TCP/IP tuple, state-full packet flow pattern (e.g., session initiation, session body and session termination), and/or packet content including application headers, e.g., video headers embedded in http packets, and payload. In some examples, the signature can be based on application, source, and destination information. The application/traffic signatures can range from congestion patterns (service, interface), to security threats such as malware, or network attacks such as DoS, or application signatures such as Netflix or torrent.

In one embodiment, each FI agent 112 performs a first pass flow identification, termed “Fast Pass FI Agent”. In one such embodiment, flows are categorized by source, destination, and application to which a distinct configuration parameter, e.g., service configuration is applied including, for example, specific streaming video, specific voice, specific online gaming service, etc. In some embodiments, this level of flow identification is sufficient for applications such as Traffic Engineering and Network Analytics but not for applications that require deeper packet inspection like that involved in protection from Viruses, Worms, and Trojans.

In one embodiment, a DPI agent is installed in one or more of agents 112 and 114. This type of agent has deep packet inspection capabilities and is often used on a second pass of inspection. A Fast Pass FI Agent is used to initially identify a flow of interest in one location in the network, passes the flow identity to the Control Unit 102, then the Control Unit 102 will message a Deep FI Agent for deeper inspection.

In some embodiments, a Distributed FI Messaging Protocol is used to pass FI information between agents 112 and 114 and control unit 102. Distributed FI Messaging Protocol is a comprehensive messaging system that is used to pass FI information between agents and control unit 102. In one embodiment, the protocol includes a cut-through mode for fast message passing between fast-path FI agents and deep FI agents or between FI agents and an external actor where latency through the control unit 102 would be a problem.

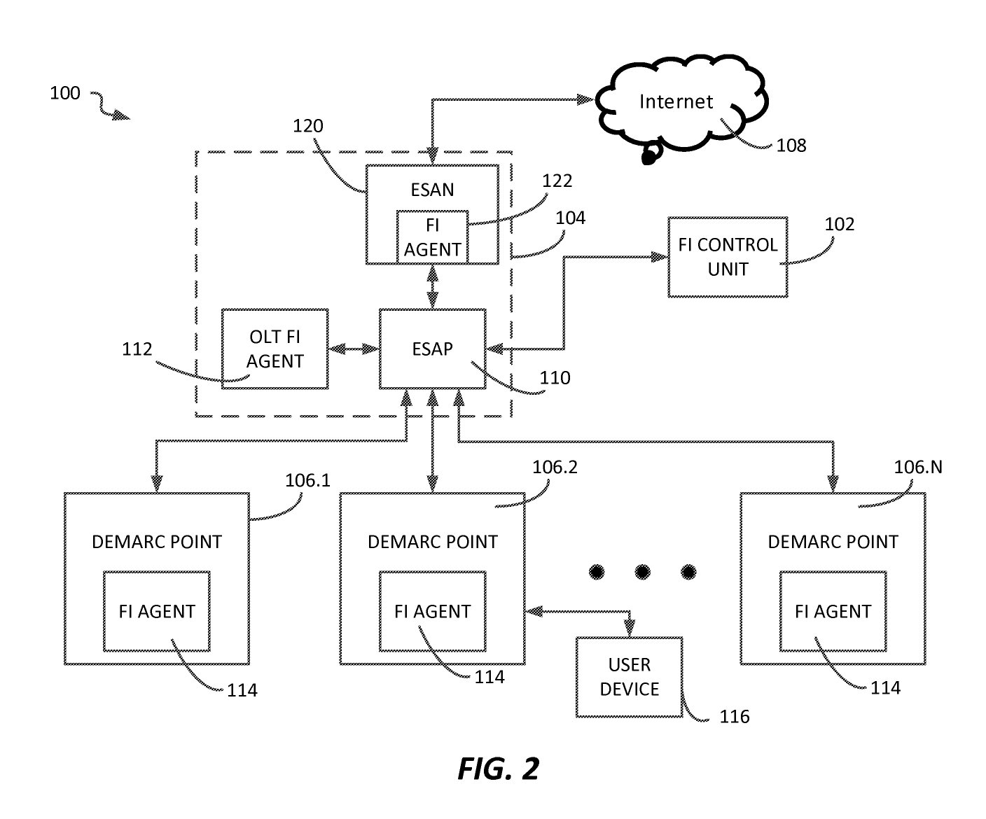

In one embodiment, such as is shown in FIG. 2, service delivery node 104 includes a service access node 120 connected between the service access platform 110 and external network 108. In one such embodiment, the service access node 120 operates to pass traffic from the external network 108 to the service access platform 110 and from the service access platform 110 to the external network 108. In one such embodiment, service access node 120 includes an FI agent 122, wherein FI agent 122 reports FI analytics information from the service access node 120 to the flow identification control unit 102. In some such embodiments, service access node 120 is a stand-alone system such the Network Analytics products made by Sandvine and by Procera Networks. In some such embodiments, a separate software-based FI agent 122 runs on the standalone device.

A method of adjusting network traffic will be discussed next. As in FIG. 1, network 100 has a service access platform 110 connected to one or more demarc points 106 and to a flow identification control unit 102. The service access platform distributes packet flows to the residential service gateways, e.g., traditional or network functions virtualizations (NFV) based gateways such as network enhanced residential gateways. The packet flows are adjusted by, first, recognizing, within each demarc point, packet flows associated with a user/subscriber passing through the demarc point. Next flow analytics information corresponding to the packet flows recognized in the demarc points is transferred from the demarc points to the flow identification control unit. At the flow identification control unit, the flow analytics information received from demarc points is analyzed and the traffic is adjusted through the service access platform and the demarc points as a function of the flow analytics information analyzed by the flow identification control unit 102.

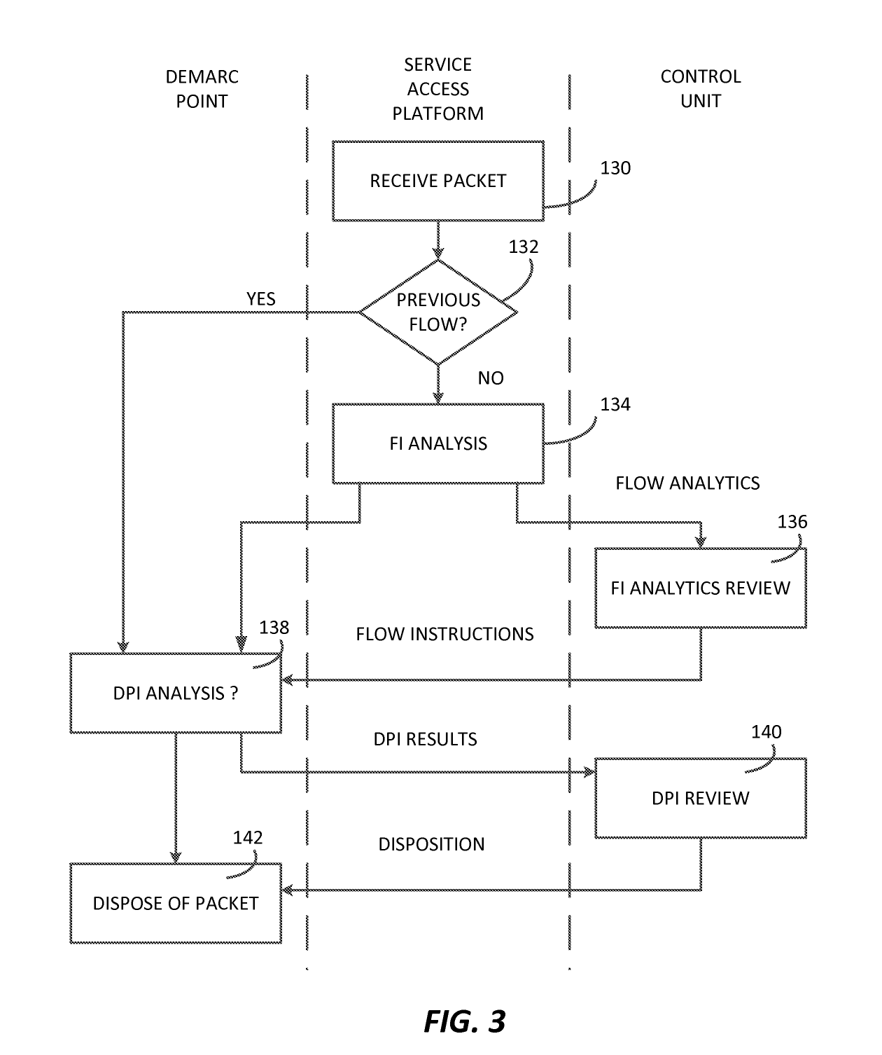

One example of a method is shown in FIG. 3. In the example embodiment shown in FIG. 3, service access platform 110 receives a packet at 130 and determines, at 132, whether the packet is part of a previously recognized packet flow. If not, control moves to 134, where a first pass flow identification is performed. The packet is then sent to the destination demarc point 106 while the results of the flow identification are sent to control unit 102 for review at 136. A message sent, at 138, from control unit 102 to the demarc point 106 that is to receive the flow. In one such embodiment, the demarc point 106 includes a DPI agent program and, if instructed to do so by the message from control unit 102, the DPI agent program performs a deep packet inspection of the packet at 138. DPI results are forwarded to control unit 102 for review at 140. Control unit 102 reviews the DPI results and determines whether to dispose of the packet. If so, demarc point 106 disposes the packet at 142.

In one embodiment, demarc points 106 serve as virtual gateways that adapt their operation as a function of the user or users attached to that demarc point 106. In one such embodiment, as discussed above, flows through a demarc point 106 can be stopped and then restarted through a second demarc point 106, e.g., after authentication of the user, in the manner discussed below. That is, a user at home (connected, e.g., to demarc point 106.2) can watch part of a movie at home, pause the action, and then restart the movie seamlessly at the user's school or business (connected, e.g., to demarc point 106.1). It will look to the user as if he had plugged his user device 116 back into demarc point 106.2. The service, e.g., access network service, and QoS characteristics within the scope of the provider follow the user once the user has been authenticated, e.g., based on device or user authentication. That is, the identified user is correlated with the services to which the user is entitled and the user is provided those services wherever the user's device enters the network in the provider's network.

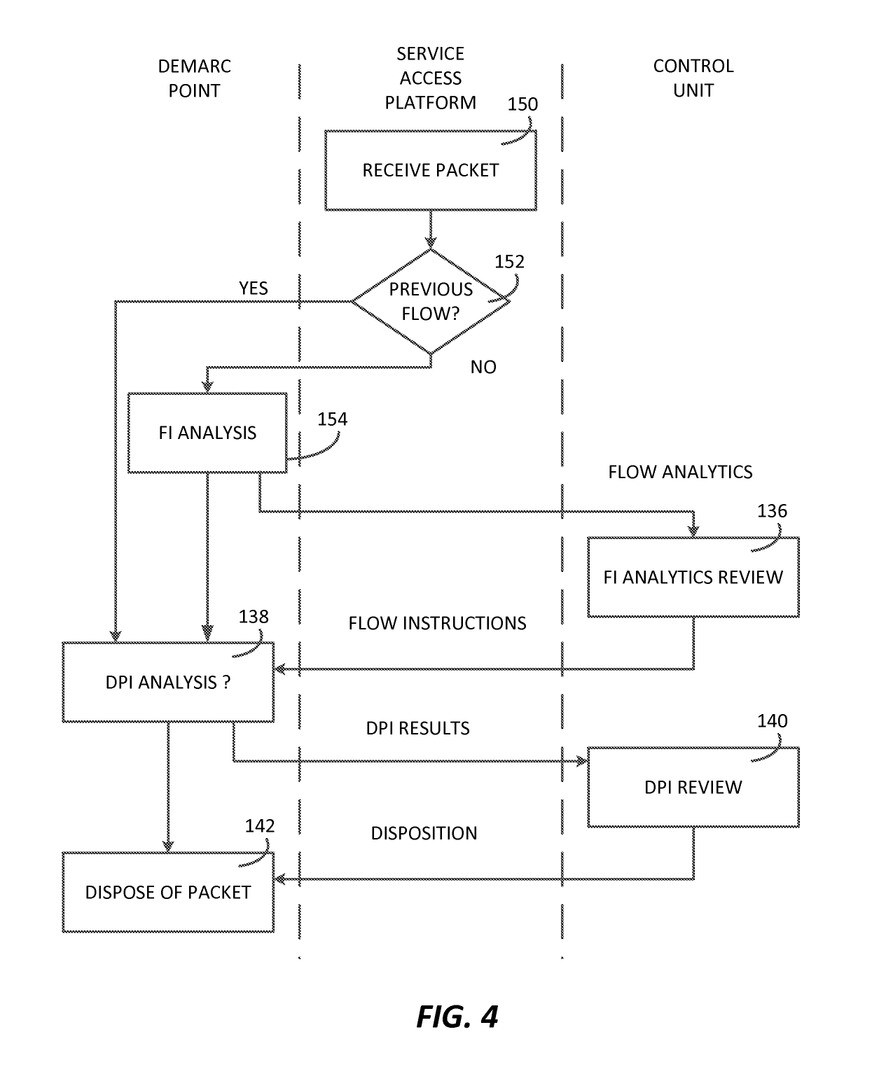

Another example embodiment is shown in FIG. 4. In the example embodiment shown in FIG. 4, service access platform 110 receives a packet at 150 and determines, at 152, whether the packet is part of a previously recognized packet flow. Meanwhile, the packet is sent to the destination demarc point 106. If the packet is not part of a previously recognized packet flow, control moves to 154 where a first pass flow identification is performed. The results of the flow identification are sent to control unit 102 for review at 136. A message sent, at 138, from control unit 102 to the demarc point 106 that is to receive the flow. In one such embodiment, the demarc point 106 includes a DPI agent program and, if instructed to do so by the message from control unit 102, the DPI agent program performs a deep packet inspection of the packet at 138. DPI results are forwarded to control unit 102 for review at 140. Control unit 102 reviews the DPI results and determines whether to dispose of the packet. If so, gateway 106 disposes the packet at 142.

A method of performing deep packet inspection (DPI) of network traffic in a network having a service delivery node 104, one or more demarc points 106 and a flow identification (FI) control unit 102 (FIG. 1) will be discussed next.

Flows passing through the demarc points 106 and associated with a user/subscriber are recognized within the demarc points and flow analytics information corresponding to the packet flows recognized in the demarc points are transferred from the demarc points to the flow identification control unit 102. Flows passing through the demarc points 106 are recognized within the service access platform and flow analytics information corresponding to the packet flows recognized in the service access platform are transferred from the service access platform to the flow identification control unit 102.

Flow identification control unit 102 analyzes the flow analytics information received from the demarc points and the service delivery node and selects, as a function of the flow analytics information analyzed by the flow identification control unit 102, a selected flow on which to perform deep packet inspection and the unit 104 or 106 that is to perform the deep packet inspection on the selected flow. Deep packet inspection of the selected flow is then performed at the selected FI agent.

In one such embodiment, analyzing the flow analytics information includes aggregating the flow analytics information received from the demarc points and the service delivery node to form a representation of the packet flows throughout the network.

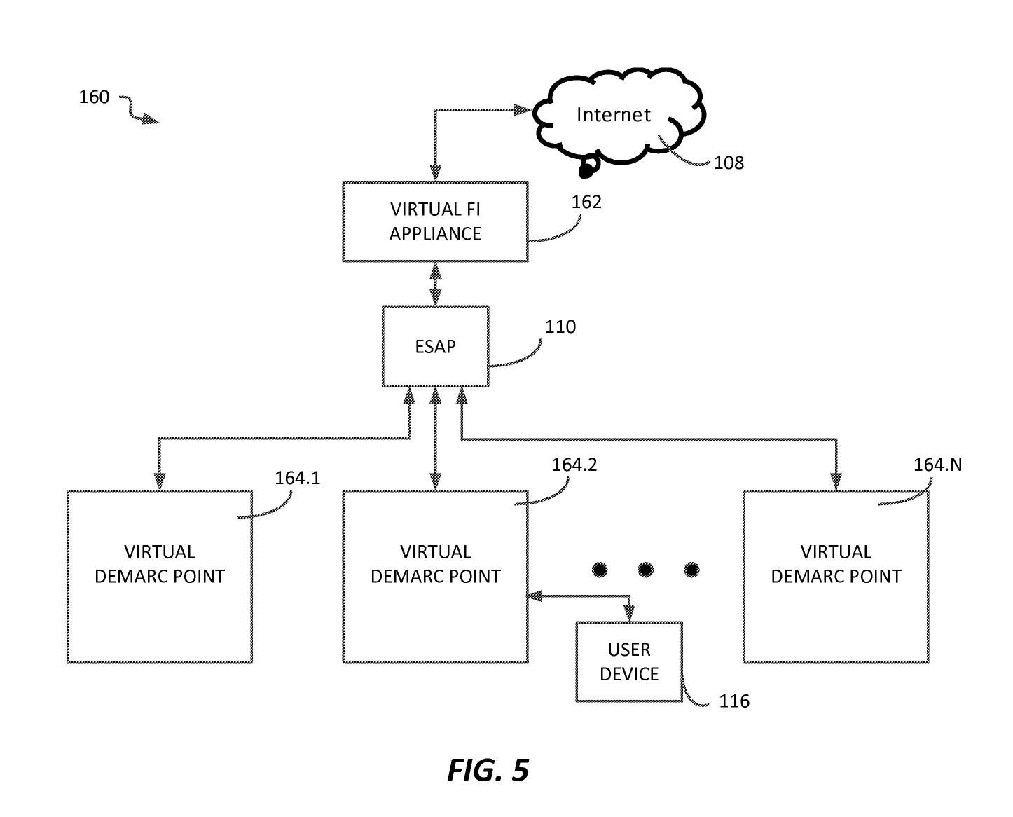

In one embodiment, analyzing the flow analytics information includes displaying the flow analytics information received from the demarc points and from the service delivery node as packet flows through a single virtual network appliance, such as the network representation 160 shown in FIG. 5. In the example network representation 160 shown in FIG. 5, network flows through the network 160 are shown as if they were being analyzed by virtual flow identification appliance 162, instead of by the FI agents distributed throughout network 100.

In one embodiment, the system of FIG. 5 includes a plurality of virtual demarc points (164.1-164.N) connected to services access platform 110. Flow identification (FI) agents operating in the demarc points and the service access platform operate to recognize flows passing through their corresponding devices and the flow identification control unit and the FI agents use a distributed DPI messaging protocol to coordinate DPI throughout the network. In one such embodiment, this DPI coordination includes detailing the signatures of applications to be analyzed. In another such embodiment, this DPI coordination includes detailing a response when a particular signature is detected. In another such embodiment, this DPI coordination includes detailing traffic to be analyzed.

In the system of FIG. 5, a virtual demarc point 164 is associated with the user. For example, the virtual demarc point 164 can be created and associated with the user based on authenticating the user at his point of access and determining the user's service profile and service history and applying appropriate treatment based on this information to the user's flows at the user's new location. This can mean through access network or between virtual demarc and user device. By way of example, if, for instance, the user is watching a movie at home using on a user device 116 such as a laptop connected to virtual demarc point 164.2 and then moves to a coffee shop, he can restart the movie on his laptop at the coffee shop with the service provided through a demarc point configured to act the same as the demarc point at home.

In one embodiment, as is shown in FIG. 2, the service delivery node 104 includes a service access node 120 connected to the service access platform 110, wherein the service network node is connected to an external network 108 and operates to pass traffic from the external network 108 to the service access platform 110 and from the service access platform 110 to the external network 108. In the embodiment shown, service access node 120 includes an FI agent 122, The FI agent 122 reports FI analytics information from the service access node 120 to the flow identification control unit 108. In some embodiments, performing deep packet inspection of the selected flow at the selected FI agent includes performing deep packet inspection in the FI agent 122 of the service access node 120. In some such embodiments, the results are displayed as if all flow analysis and deep packet inspection are performed in virtual flow identification appliance 162.

In one embodiment, control unit 102 decides where to perform packet flow analysis. In one such embodiment, unit 102 performs analysis as close to the subscriber as possible. Thus, a preference is given to performing flow analysis at the gateway 106 over the service access platform 110, and at the service access platform 110 over service access node 120. Decisions can, therefore, be made as close to the subscriber as possible.

In some embodiments, each agent has a profile that looks for certain events or conditions. For example, one agent may note “Netflix flow has started”, “Netflix flow has stopped”, and “Skype flow has started”. Real-time information on the start and stop of certain packet flows can be advantageous in recognizing and taking action on security issues related to the packet flows.

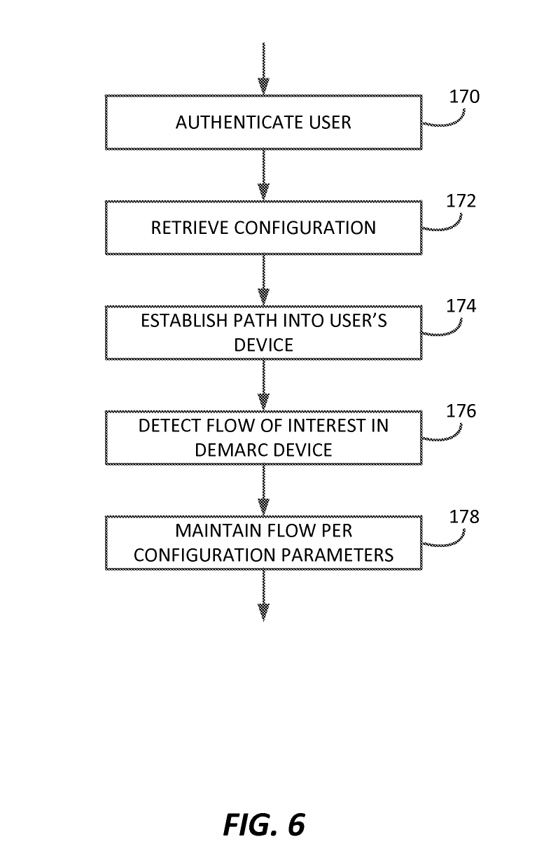

A method of switching flows between demarc points will be discussed next. As shown in FIG. 6, a user connects and authenticates himself at 170. A check is made at 172 to determine if any flows had been interrupted during the user's previous session and, if so, the bandwidth profile (BWP) and QoS, for example of each interrupted flow is retrieved from storage, e.g., available at the subscriber's home user network interface when a flow is active. The BWP and QoS associated with the flow need to be re-established. If the user starts a new flow that may utilize a distinct QoS and BWP per the user's services, then it should also be identified via FI/deep FI and provided the appropriate BWP/QoS treatment. In one embodiment this configuration information is stored at service delivery node 104. In another embodiment, this configuration information is stored at FI control unit 102. In other embodiments, the configuration information is stored within one or more demarc points 106.

If the user restarts an interrupted flow through a different demarc point 106, a secure communications path is established at 174 through demarc point 106.2 to user device 116.

At 176, the flow corresponding to the interrupted service is detected in agent 112 or agent 114, and that flow is maintained per the recovered configuration parameters, e.g., service configuration parameters, as shown at 178. In some example implementations, it can be desirable to check the user's traffic for undesirable traffic patterns such as viruses, worms, and the like.

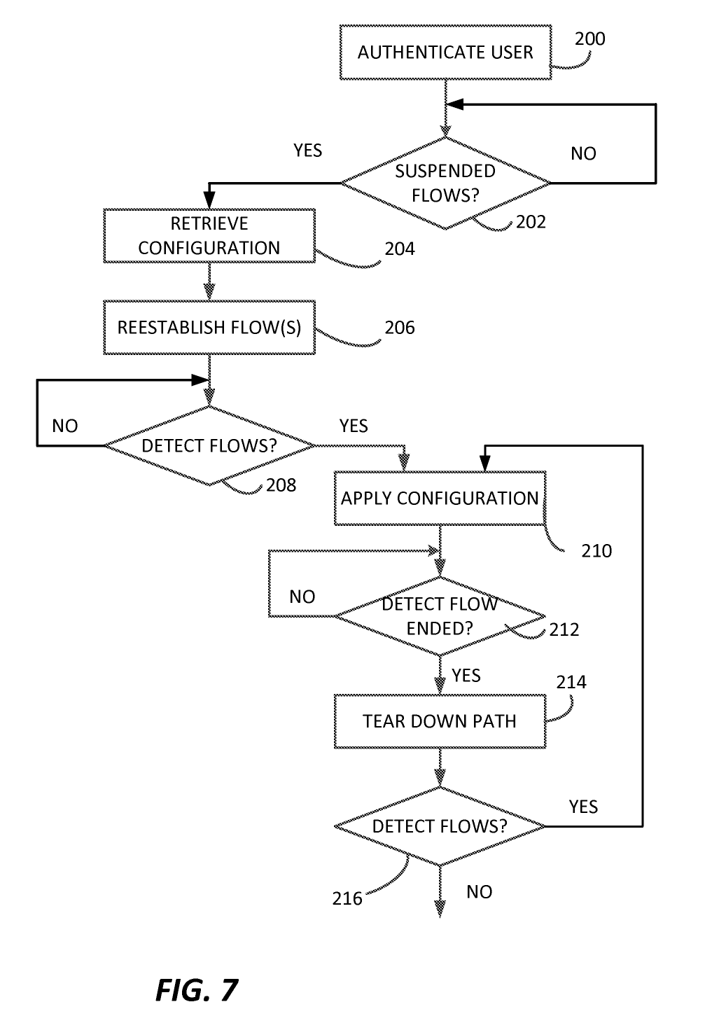

A method of reestablishing a flow is shown in FIG. 7. In the example shown in FIG. 7, at 200, a user authenticates himself or herself to system 100. System 100 then checks at 202 to see if any flows associated with that user are suspended or if there is a new flow associated with the virtual demarc point for the user. If so, control moves to 204, and configuration information associated to the suspended flow/new flow and the authenticated user is retrieved. In some examples, suspending a flow includes terminating and then re-activating a session when the user's device connects from a demarc point with a specific application signature requiring a specific QoS treatment.

Any suspended flows are reestablished at 206 and, when flows are detected at 208, control moves to 210, where the retrieved configuration parameters are applied to the detected flows. This continues until one of the flows ends at 212, when system 100 tears down the path at 214 and then moves to detect flows at 216.

In one example embodiment, a method is implemented for switching flows between demarc points. In one such embodiment, system 100 includes a network having a service access platform 110 connected to two or more demarc points 106 and to a flow identification control unit 102. Demarc points 106 include a first and a second demarc point wherein the service access platform distributes packet flows to the demarc points.

System 100 switching flows between demarc points by recognizing, within each demarc point, packet flows passing through the demarc point, transferring flow analytics information corresponding to the packet flows recognized in the demarc points from the demarc points to the flow identification control unit, analyzing, within the flow identification control unit, the flow analytics information received from the demarc points, and establishing a first packet flow to a user through the first demarc point, wherein establishing includes creating a secure communications path through the first demarc point and transferring the first packet flow to the user via the secure communications path through the first demarc point.

When packet flow through the first demarc point is suspended, it can be reestablished through any of the demarc points 106 after a user authenticates himself or herself to the system. In one embodiment, reestablishing the first packet flow to the user through the second demarc point 106.2 can include creating a second secure communications path through the second demarc point, retrieving configuration parameters, e.g., service configuration parameters, associated with the transfer of the first packet flow through the first demarc point and transferring the first packet flow to the user via the second secure communications path using the configuration parameters. In some examples, the demarc points can be virtualized, so transferring a packet flow can include an exchange with a data center.

What has been discussed above is the distribution of flow analysis across two or more appliances in a demarc point services network. Such an approach takes advantage of the use of inexpensive software or hardware-based flow inspection applications to analyze packet flows through network 100 under control of a flow identification control unit 102. The results can be displayed as if being performed by one or more virtual network appliances for ease of understanding. An advantage of such an approach is that you avoid having to split out or mirror network traffic to perform analysis of particular packet flows. In addition, flow analysis can be tuned to the needs of network 100. That is, various degrees of packet inspection can be used based on the agent installed and the security needs of the system. In addition, analysis can be performed real-time, with the results used to adjust packet flow to support desired quality of service parameters.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. In a network having a service access platform connected to two or more demarcation points and to a flow identification control unit, wherein the demarcation points include a first and a second demarcation point wherein the service access platform distributes packet flows to the demarcation points, a method of switching flows between demarcation points, the method comprising:
recognizing, within each demarcation point, packet flows passing through the demarcation point;
transferring flow analytics information corresponding to the packet flows recognized in the demarcation points from the demarcation points to the flow identification control unit;
analyzing, within the flow identification control unit, the flow analytics information received from the demarcation points;
establishing a first packet flow to a user through the first demarcation point, wherein establishing includes creating a secure communications path through the first demarcation point and transferring the first packet flow to the user via the secure communications path through the first demarcation point; and
reestablishing the first packet flow to the user through the second demarcation point, wherein reestablishing includes creating a second secure communications path through the second demarcation point, retrieving configuration parameters associated with the transfer of the first packet flow through the first demarcation point and transferring the first packet flow to the user via the second secure communications path using the configuration parameters.

2. The method of claim 1, wherein transferring the first packet flow through the first demarcation point includes receiving a quality of service requirement from the user, storing the quality of service requirement as one of the configuration parameters and applying the quality of service requirement to the first packet flow through the first demarcation point; and
wherein reestablishing the first packet flow to the user through the second demarcation point includes retrieving the stored quality of service requirement and applying the quality of service requirement to the first packet flow through the second demarcation point.

3. The method of claim 1, wherein analyzing the flow analytics information includes aggregating the flow analytics information received from the demarcation points to form a representation of the packet flows throughout the network.

4. The method of claim 1, wherein analyzing the flow analytics information includes displaying the flow analytics information received from the demarcation points and from the service access platform as packet flows through a single network appliance.

5. The method of claim 1, wherein creating a second secure communications path through the second demarcation point includes authenticating the user through the second demarcation point.

6. In a network including a service access platform connected to one or more demarcation points and to a flow identification control unit, wherein the service access platform distributes packet flows to the demarcation points, including a first and a second demarcation point, a flow transfer method comprising:
recognizing, within each demarcation point, packet flows passing through the demarcation point;
transferring flow analytics information corresponding to the packet flows recognized in the demarcation points from the demarcation points to the flow identification control unit;
analyzing, within the flow identification control unit, the flow analytics information received from the demarcation points; and
adjusting traffic through one or more of the service access platform and the demarcation points as a function of the flow analytics information analyzed by the flow identification control unit, wherein adjusting includes storing configuration parameters of flows through the first demarcation point that are associated with a user;
suspending one or more of the flows associated with the user;
authenticating the user through the second demarcation point; and
reestablishing the suspended flows through the second demarcation point, wherein reestablishing includes adjusting the reestablished flows as a function of the stored configuration parameters.

7. The method of claim 6, wherein the demarcation points include deep packet inspection capability and wherein adjusting includes performing a deep packet inspection on one or more packet flows and reporting results of the deep packet inspection to the flow identification control unit.

8. The method of claim 6, wherein analyzing the flow analytics information includes categorizing packet flows by application, source and destination.

9. The method of claim 6, wherein analyzing the flow analytics information includes aggregating the flow analytics information received from the demarcation points to form a representation of the packet flows throughout the network.

10. A system for distributing content, comprising:
a flow identification control unit;
a plurality of demarcation points, including a first and a second demarcation point, wherein each demarcation point includes a flow identification (FI) agent, wherein the flow identification agent on each demarcation point analyzes packet flows through the demarcation point and communicates the packet flow identifications to the flow identification control unit; and
a service delivery node communicatively coupled to the flow identification control unit and to the demarcation points, wherein the service delivery node includes a service access platform and a flow identification agent, wherein the flow identification agent identifies packet flows through the service access platform and communicates the packet flow identifications to the flow identification control unit;
wherein the flow identification control unit analyzes the flow analytics information received from the demarcation points and the service delivery node and stores the analysis in memory; and
wherein a user connected to the first demarcation point is able to suspend one or more of the flows associated with the user through the first demarcation point, authenticate the user through the second demarcation point and reestablish the suspended flows through the second demarcation point, wherein reestablishing includes adjusting the reestablished flows as a function of transfer parameters associated with the flow through the first demarcation point.

11. The system of claim 10, wherein analyzing includes transmitting commands to the service access platform to adjust traffic through the service access platform as a function of the flow analytics information.

12. The system of claim 10, wherein analyzing includes transmitting commands to one or more of the demarcation points to adjust traffic through the demarcation points as a function of the flow analytics information.

13. The system of claim 10, wherein the service delivery node further includes a service access node connected to the service access platform, wherein the service access node is connected to an external network and operates to pass traffic from the external network to the service access platform and from the service access platform to the external network;
wherein the service access node includes an FI agent, wherein the FI agent reports FI analytics information from the service access node to the flow identification control unit.

14. The system according to claim 10, wherein the service access platform flow identification agent is an optical line terminal (OLT) flow identification agent.

15. The system according to claim 10, wherein the service access platform flow identification agent is a Fast Path FI agent.

16. A method of modifying network traffic through a network having a service delivery node connected to one or more demarcation points, including a first and a second demarcation point, to a flow identification control unit and to an external network, wherein the service delivery node distributes packet flows to the demarcation points, the method comprising:
recognizing, within each demarcation point, packet flows passing through the demarcation point;
transferring flow analytics information corresponding to the packet flows recognized in the demarcation points from the demarcation points to the flow identification control unit;
recognizing, within the service delivery node, packet flows passing through the service access platform and the service access node to one or more demarcation points;
transferring flow analytics information corresponding to the packet flows recognized in the service access platform and the service access node from the service delivery node to the flow identification control unit;
analyzing, within the flow identification control unit, the flow analytics information received from the demarcation points and the service delivery node; and
adjusting traffic through the service access node, the service access platform and the demarcation points as a function of the flow analytics information analyzed by the flow identification control unit, wherein adjusting includes storing configuration parameters of flows through the first demarcation point that are associated with a user;
suspending one or more of the flows associated with the user;
authenticating the user through the second demarcation point; and
reestablishing the suspended flows through the second demarcation point, wherein reestablishing includes adjusting the reestablished flows as a function of the stored configuration parameters.

17. The method of claim 16, wherein analyzing the flow analytics information includes categorizing packet flows by application, source, and destination.

18. The method of claim 16, wherein analyzing the flow analytics information includes aggregating the flow analytics information received from the demarcation points, the service access node and the service access platform to form a representation of the packet flows throughout the network.

19. The method of claim 16, wherein analyzing the flow analytics information includes displaying the flow analytics information received from the demarcation points, from the service access node and from the service access platform as packet flows through a single network appliance.

20. The method of claim 16, wherein analyzing includes tasking one of the demarcation points to perform deep packet inspection of one of the packet flows through the demarcation point and receiving the results of the deep packet inspection.

21. The method of claim 16, wherein analyzing includes tasking the service delivery node to perform deep packet inspection of one of the packet flows in one of the service access platform and the service access node and receiving the results of the deep packet inspection.
